(19) United States
(12) Patent Application Publication
(10) Pub. No.: US 2026/0203037 A1
(43) Pub. Date: Jul. 16, 2026

(54) UPGRADE TO A COMPUTING SYSTEM CLUSTER

(71) Applicant: Dell Products L.P., Round Rock, TX (US)

(72) Inventors: Alexander Bahm, Renton, WA (US); Gene W. Lee, Seattle, WA (US); Rahul Bora, Shoreline, WA (US)

(21) Appl. No.: 19/023,252

(22) Filed: Jan. 15, 2025

(51) Int. Cl. G06F 8/65

(52) U.S. Cl. CPC G06F 8/65

(57) ABSTRACT

An upgrade manager may determine to simultaneously upgrade multiple computing system nodes corresponding to a computing system cluster. The manager may cooperate with an upgrade supervisor, which may correspond to a particular node, to facilitate obtaining node state information corresponding thereto. An upgrade agent corresponding to the upgrade supervisor may determine node state information corresponding to at least one of the nodes. If, based on the determined state information, rebooting one of the nodes would likely result in no access by a client computing system to the cluster, and would thus result in data unavailability with respect to the client, rebooting of the node may be avoided.

### BACKGROUND

Computing systems nodes may be rebooted after being placed into service to facilitate, inter alia, upgrading at least one software component corresponding to the computing system node to add a new software component or to update at least one software version to a new version.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise obtaining, by at least one computing system comprising at least one processor, node state information corresponding to at least one node associated with at least one computing system cluster an analyzing, by the at least one computing system, the node state information with respect to at least one upgrade criterion to result in analyzed node state information. Based on the analyzed node state information being determined to fail to satisfy the at least one upgrade criterion, the method may further comprise facilitating, by the at least one computing system, restricting at least one of the at least one node from performing at least one upgrade operation to result in at least one restricted upgrade operation.

In an example embodiment, the obtaining of the node state information may be facilitated by at least one virtual computing agent corresponding to the at least one computing system. In an example embodiment, the at least one virtual computing agent may be executed by at least one computing component corresponding to the at least one computing system.

In an example embodiment, the node state information may be communicated to at least one virtual computing supervisor being executed by at least one computing component corresponding to the at least one computing system cluster. In an example embodiment, the at least one virtual computing agent may be facilitated by at least one application programming interface.

The at least one upgrade operation may comprise rebooting the at least one node.

In an example embodiment, the node state information may correspond to a determination that the node state information has been determined to fail to satisfy the at least one upgrade criterion. The method may further comprise determining, by the at least one computing system, that performing the at least one upgrade operation is threshold likely to result in at least one network pool, corresponding to the at least one node, being unavailable, or not providing access to an active node, during the at least one upgrade operation. The at least one network pool being determined to be unavailable during the at least one restricted upgrade operation may be based on the at least one node being a sole node, corresponding to the at least one network pool, available for use by the at least one network pool.

In an example embodiment, the at least one restricted upgrade operation may comprise avoiding, by the at least one computing system, facilitating rebooting of the at least one node and reporting, by the at least one computing system to an upgrade manager, that the at least one node is not upgraded.

In an example embodiment, the at least one network pool may correspond to a single network address. In an example embodiment, the at least one network pool may correspond to multiple network addresses.

In an example embodiment, the at least one node may be a first node. The at least one computing system cluster may comprise the first node and an available second node. The at least one network pool may correspond to the first node and the available second node. The available second node may be configured to facilitate dynamic failover network connectivity with respect to the at least one computing system cluster according to a network address that is not unique to the first node. The at least one restricted upgrade operation may comprise rebooting the first node.

In another example embodiment, a computing system may comprise at least one processor configured to process executable instructions that, when executed by the at least one processor, facilitate performance of operations that may comprise determining node state information corresponding to at least one node associated with at least one computing system cluster and analyzing the node state information with respect to at least one upgrade criterion to result in analyzed node state information. Based on the analyzed node state information being determined to fail to satisfy the at least one upgrade criterion, the operations may further comprise initiating at least one restricted upgrade operation.

In an example embodiment, the analyzed node state information being determined to fail to satisfy the at least one upgrade criterion may comprise at least one minimum node value failing to be satisfied during at least one upgrade operation. The at least one minimum node value may comprise at least one of: at least one percentage of the at least one node being available during at least one reboot operation corresponding to the at least one node, or at least quantity of the at least one node being available during at least one reboot operation corresponding to the at least one node.

In an example embodiment, the analyzed node state information comprises a determined number of connections corresponding to the at least one node during a configured tracking period. The analyzed node state information being determined to fail to satisfy the at least one upgrade criterion may comprise the determined number of connections failing to be less than or equal to a number specified by a configured connection occurrence criterion.

In an example embodiment, the analyzed node state information may further comprise a determined quantity of traffic corresponding to the determined number of connections during the configured tracking period. The analyzed node state information being determined to fail to satisfy the at least one upgrade criterion may further comprise the determined quantity of traffic failing to be less than or equal to a number specified by a configured traffic quantity criterion.

In an example embodiment, the operations may further comprise determining a number of connections corresponding to the at least one node during at least one configured tracking period to result in at least one predicted non-use period corresponding to the at least one node. The at least one restricted upgrade operation may comprise avoiding rebooting the at least one node during a period other than the at least one predicted non-use period and rebooting the at least one node during the at least one predicted non-use period.

In yet another example embodiment, a non-transitory machine-readable medium may comprising executable instructions that, when executed by at least one processor of a cluster computing system, may facilitate performance of operations that may comprise determining node state information corresponding to at least one node associated with cluster computing system and analyzing the node state information with respect to at least one upgrade criterion to result in analyzed node state information. Based on the node state information, the operations may further comprise determining that upgrading, during at least one upgrade period, at least one node corresponding to the cluster computing system is threshold likely to result in network access to the cluster computing system via at least one network access resource being unavailable during the at least one upgrade period. The operations may further comprise avoiding, during the at least one upgrade period, upgrading the at least one node.

In an example embodiment, the at least one network access resource may comprise a network address that corresponds to a sole access resource, corresponding to at least one client computing system other than the cluster computing system, via which the at least one client computing system is capable of accessing the cluster computing system.

In an example embodiment, the at least one node corresponding to the cluster computing system that is determined to threshold likely result in network access to the cluster computing system via the at least one network access resource being unavailable during the at least one upgrade period may be a first node. The operations may further comprise initiating upgrading of a second node corresponding to the cluster computing system during the at least one upgrade period to result in an initiated upgrade operation and determining that the initiated upgrade operation corresponds to an initiated upgrade operation duration that equals or exceeds an upgrade duration threshold. Based on the initiated upgrade operation being determined to correspond to the initiated upgrade operation duration that equals or exceeds an upgrade duration threshold, the operations may further comprise initiating upgrade of the first node.

In an example embodiment, the operations may further comprise determining a number of connections corresponding to the at least one node during at least one configured tracking period to result in at least one predicted non-use period corresponding to the at least one node and rebooting the at least one node during the at least one predicted non-use period.

### BRIEF DESCRIPTION OF THE DRAWINGS

FIG. 1 illustrates a computer networking environment.

FIG. 2 illustrates a computing system cluster comprising multiple node neighborhoods that each comprise multiple nodes.

FIG. 3 illustrates an example virtual computing agent being used to facilitate determining whether a computing system node may be rebooted to facilitate an upgrade.

FIG. 4 illustrates an example computing system cluster comprising multiple nodes with each node being configured to execute an upgrade module and a virtual computing upgrade agent.

FIG. 5 illustrates an example computing system connection diagram.

FIG. 6 illustrates an example flow diagram of an example embodiment method to determine whether a computing system node may be rebooted to implement an upgrade with respect to the node.

FIG. 7 illustrates a block diagram of an example method embodiment.

FIG. 8 illustrates a block diagram of an example computing system.

FIG. 9 illustrates a block diagram of an example non-transitory machine-readable medium embodiment.

FIG. 10 illustrates an example computer environment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

A disjoint network may comprise nodes in different node neighborhoods corresponding to a computing system cluster that may be associated with a network resource pool with respect to which data unavailability may result during a parallel upgrade operation.

Embodiments disclosed herein may facilitate updating, or upgrading, at least one computing node of a cluster of computing nodes. Embodiments disclosed herein may facilitate an upgrade engine, or module, querying a network to determine whether all networks a computing system node may correspond to would remain available if the node were to reboot. A network computing system may determine which of at least one network node is currently usable and may assess whether, if a specific node were to become unavailable, for example due to rebooting, if an entire network pool (e.g., a pool of resources such as, for example, network addresses associated with a network) would become unavailable. In an example embodiment, if a node is not configured to correspond to a network the node may be rebooted.

According to an example embodiment, if a computing system node is configured to be accessed via a network and rebooting of the node would likely result in lack of access, via the network, by a client computing system to the node, or to a cluster that comprises the node, upgrading, or rebooting, of the node may be avoided, at least for a configured period. An upgrade agent may facilitate, at a later time, upgrading or rebooting of the node if the agent determines that the later upgrading/rebooting would likely not result in data unavailability with respect to the cluster, or node, by the client computing system via the network. If the pool corresponds to only one node the node may be rebooted even if data unavailability would likely result because eventually data unavailability, due to reboot, is inevitable with respect to the node. In the case of a network providing access to only one node of a cluster, upgrading or rebooting of the node may be scheduled to occur during a period corresponding to likely low usage of the node, which may be based on historical node state information corresponding to the node. In an embodiment, an alert or notification message may be sent, for example to an administrator associated with the node, requesting, or recommending, that at least one additional node be configured with respect to the network to minimize potential data unavailability. In an example embodiment, before an upgrade, administrators associated with a network configured to access as single node may be notified of potential data unavailability during node reboot unless the network is assigned to more than one node of a cluster.

In an example embodiment, a determination may be made whether a network pool (e.g., one or more network addresses) will remain online/available to facilitate access to a cluster if a node corresponding to the pool is rebooted (e.g., a determination may be made whether a network pool of resources can be used by a client computing system to access the cluster if a node that the client computing system is configured to access via the pool is rebooted). If a determination is made that access via the network pool will likely not remain available during a reboot of a node associated with the pool, a determination may be made to determine whether the network may use, or may be configured to use, virtual/failover network addresses. If so, a determination may be made to determine whether another node may be assigned to, or configured to operate with, the network and associated addresses to facilitate having a node that is configured to operate with the network being online while another node associated with the network is rebooted. If another node can be configured to operate with a network that otherwise is configured to operate with a single node, the other node may be, at least temporarily, configured to operate with the network to facilitate access via the network to a cluster that may comprise the single node while the single node is rebooted.

In addition to avoiding, or minimizing, network pools without access to at least two nodes going offline during upgrade/reboot operations, other benefits may be realized by implementing embodiments disclosed herein. For example, a required availability of each network pool may be maintained, scaling disruption tolerance may be maintained, or unused networks may be automatically determined.

Avoiding, or minimizing, network pools without access to at least two nodes going offline upgrade/reboot is desirable because a network pool associated with a large number of nodes (e.g., 100 nodes) would likely become unusable due to resource exhaustion if an entire workload being facilitated by the large number of nodes were to be facilitated by a single node. According to an example embodiment, a minimum percentage of nodes/network address may be required to be available during an upgrade to facilitate the pool not only staying online but to facilitate having a reasonable fault tolerance threshold, which may be based on a system default, a pool size, or an administrator definition/configuration. Allowing administrators to configure a fault tolerance threshold may facilitate limiting disruptions to important workloads while allowing ‘background task’ workloads to experience more disruption by altering a desired criterion from ‘keep the pool online’ to ‘does the pool still meet or exceed a configured required availability.’

An upgrade of nodes may become serialized or blocked due to an unusual network configuration or condition. Although a slow upgrade of at least one node is undesirable, and it is desirable to avoid client computing systems experiencing disruption or data unavailability, if upgrade progress has slowed such that an upgrade may not complete before the end of a determined period, for example a determined maintenance time period or ‘window’, a configurable amount of disruption or data unavailability may be tolerable. Some amount of disruption or data unavailability may be tolerable with respect to some ‘background task’ workloads while disruption or data unavailability with respect to more critical tasks may be less tolerable. Accordingly, example embodiments disclosed herein may facilitate identifying networks or circumstances with respect to which disruption or data unavailability may be tolerable for certain computing workloads while critical workloads’ availability may be maintained.

Although allowing disruption or data unavailability may be tolerable under some circumstances, allowing of disruption may nevertheless be considered as a fallback mechanism. Accordingly, it is desirable that allowing of disruption or data unavailability for certain workloads and under certain circumstances is minimized. To facilitate minimizing disruption or data unavailability, a network administrator may label a network that can be disrupted automatically to facilitate upgrade without rescheduling. For example, a network administrator may configure a network to automatically experience disruption if upgrade with respect to the network is blocked or serialized. To facilitate making a determination that automatic disruption or data unavailability may be implemented, an upgrade instance may maintain at least two metrics or measured values: a time since a last node started an upgrade/reboot and a rolling average value corresponding to how many nodes may be upgrading/rebooting at a query time (e.g., an average number of nodes rebooting during a configured time window that moves with respect to time according to a configured rate).

As an example, if an average upgrade time plus fifty percent of the average upgrade time has passed since the last node has started upgrading, it may be assumed that an upgrade has stalled. An upgrade process/module/engine may receive indication from a network that a node that may be currently blocked may be rebootable. If a network that is blocking upgrade progress allows disruption if the upgrade is blocked, evaluation as to whether to postpone rebooting of a node may be automatically skipped. If the rolling average for a recent period, for example the past one hour, has been a single node upgrading at a time, it may be assumed that that upgrading of nodes has serialized, in which case an upgrade process may indicate to a network that upgrading of nodes has serialized and a determination may be made whether other new nodes may be upgraded/rebooted.

In an example embodiment, an administrator may label a network that can only be disrupted by further instruction. In the event that an upgrade is taking too long, an administrator may invoke a “go faster” enhancement that may increase the speed of an upgrade process while also potentially increasing disruption. To ensure that a “go faster” enhancement does not cause more disruption than a tolerable amount, an administrator may provide a list of networks that can tolerate disruption.

Instead of relying on administrators to make decisions and explicitly indicate to one or more networks various state information corresponding to various computing workflows, telemetry corresponding to a network may be enhanced by tracking usage (e.g., clients connected via a network to a node and performing work) and indicating which networks are currently in use. Furthermore, tracking when a network is used could be incorporated into node reboot management. Information indicative that a network has not been used for a determined period may be indicative that a node corresponding to the network may be safely taken offline temporarily during a reboot. In addition, identifying usage patterns, such as, for example, a network is only used between 9:00 AM – 5:00 PM, may facilitate a determination being made not to disrupt a network pool at 8:55 AM because the network may likely be in use five minutes later.

According to at least one example embodiment, use of a network during a specific tracking period may be determined by tracking at least one identified network connection and determining whether data has been sent via the at least one connection during the tracking period. Determination of use of the at least one network to transport data may comprise whether data during the specific tracking period equals or exceeds a configured threshold criterion. The threshold criterion may facilitate distinguishing between client computing systems actively engaged in productive work or just sending ‘keep-alive’ messages. If a client computing system is determined to be active based on an amount of data corresponding there to being transported via in particular network (e.g., the network is determined to be active), the network may be indicated locally (e.g., with respect to a cluster that comprises the network) as active during the tracking period. Network data usage over an extended period (e.g., longer than a tracking period) may be represented by an array of arrays of Boolean indications corresponding to each of multiple networks. A first array may represent a day and a second array may represent time slices of the day wherein a network has been determined to have been active. In an embodiment, time slices corresponding to periods greater than fifteen-minute granularity may be configured to account for natural computing system usage variations. In an embodiment, to facilitate tracking of data usage trends, and to facilitate understanding of week-to-week behavior differences, the first array may be at least twenty-one elements and may be multiples of seven. The first array may be considered a circular array that loops back from the end of the array to the first element of the array. Indexing corresponding to the array may be configured to be consistent (e.g., indexing may not be reset at the end of a year to avoid discontinuous tracking of data usage). Accordingly, an array index may be configured as a number of days since a configured time (e.g., the Unix epoch) modulus by the length of the array.

In an example embodiment, to aggregate results with respect to a cluster, an ‘array of arrays’ may be consolidated into a single location, and logical functions may be applied to data corresponding thereto, for example, logical OR functions, a result of which may be indicative of when a particular network has been active with respect to a cluster during a tracking period. To account for (e.g., to filter out) week-to-week noise, a per-week average may be generated by generating a new array of array of Boolean values corresponding to an array of days having a length of seven. An OR function may be applied to each week of results that result from previously aggregated results to result in a one-week combined result. A response to a query of the combined result using an index value may be used to determine a usage level, or amount, corresponding to the network. In an example embodiment, an evaluation that ‘advances forward’ with respect to time slices may be used to determine whether the network is likely to be used at a time when a node corresponding to the network may be rebooting. ‘Advancing forward’ may refer to evaluating a next index in the second array (e.g., within an array of arrays according to a configured formula, for example, avg_upgrade_time * 2/length_of_time_slice.

Having an understanding of times during which a network is active may facilitate determining at least one time frame during which disruption may be allowed, or tolerated, while ensuring that the disruption is resolved before the network becomes active again. To minimize a scenario wherein an error message is indicated with no context corresponding to the error being indicated, if a node is not permitted to be upgraded/rebooted, identifiers or indications may be generated that are indicative of network pools with respect to which an availability requirement may be violated if a node were to be upgraded/rebooted. Accordingly, indication of a node with respect to which upgrade rebooting is paused or delayed may facilitate an administrator in identifying a problematic network or a problematic network configuration that could be reconfigured to avoid data unavailability if a node is rebooted.

According to conventional techniques, a problem may exist that every node corresponding to a network pool may be configured in a different node neighborhood and if all nodes corresponding to the network are upgraded simultaneously the network pool may go offline (e.g., a client computing system may not be able to access data stored by a cluster that comprises a node, or nodes, that is/are rebooting). In such a scenario, an administrator may need to reconfigure a network or may need to use a rolling upgrade method technique that may reboot one node at a time. Reconfiguring, by an administrator, a network to perform an upgrade is undesirable and such reconfiguration may be impracticable with respect to time if a maintenance time window has begun. Thus, according to conventional techniques, a network administrator may choose a slower, rolling upgrade system process instead of reconfiguring the network.

According to example embodiments disclosed herein, problems associated with conventional may be solved such that administrators may not be required to reconfigure a network to facilitate upgrading a computing system node using a method other than a rolling one-at-a-time technique (e.g., an administrator may choose a parallel node upgrade process) while facilitating all networks remaining available, except for possibly single-node networks. Although a parallel/simultaneous upgrade may in some cases operate as a rolling one-at-a-time upgrade if unusual network configurations or conditions arise, a node upgrade according to embodiments disclosed herein may not be operated as a rolling upgrade for an entire upgrade process and instead may automatically change between one-at-a-time and parallel upgrade responsive to changing network and cluster configurations and conditions.

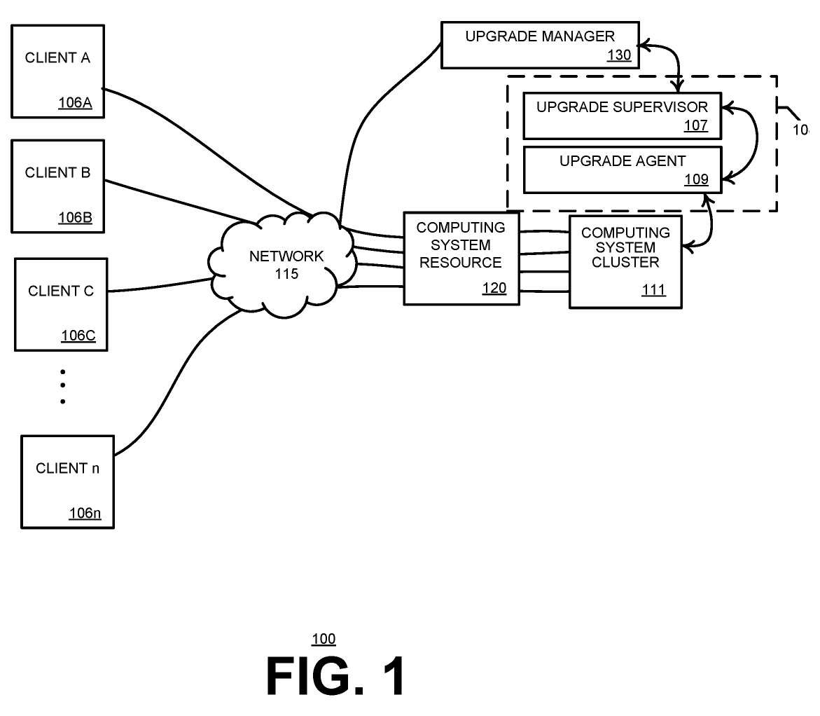

Turing now to FIG. 1, the figure illustrates a computing network environment 100. Client computing systems 106A – 106n are shown coupled to computing system cluster 111 via computing network 115. At least one client computing system 106 may access computing system cluster 111 via one or more computing system resource(s) 120. A computing system resource 120 may comprise an access point, an Internet Protocol address, a network address, or another addressable component that may correspond to, and that may facilitate connection of the client computing system to, computing system cluster 111. Computing system resources 120 that may facilitate computing system 106 accessing nodes corresponding to cluster 111 may be referred to as a network pool, which may comprise, or correspond to, one or more access point(s), Internet address(s), network address(s), or other addressable component(s), etc.. A client computing system 106 may access one node corresponding to computing system cluster 111 via multiple computing system resources 120. A client computing system 106 may access one node corresponding to computing system cluster 111 via a single computing system resource 120. A client computing system 106 may access multiple nodes corresponding to computing system cluster 111 via multiple computing system resources 120. A client computing system 106 may access multiple nodes corresponding to computing system cluster 111 via a single computing resource 120. Upgrade manager 130 may be coupled to network 115 and may provide an interface to a computing system entity that may facilitate operation of computing system cluster 111. Upgrade manager 130 may communicate with at least one upgrade supervisor 107 which in turn may communicate with at least one upgrade agent 109. At least one upgrade agent 109 may be used to determine node status information corresponding to nodes that may correspond to computing system cluster 111. An upgrade supervisor 107 and an upgrade agent 109 may be distinct components, modules, instances, or services. In an example embodiment, an upgrade component/module/instance/service 108 may comprise at least one upgrade supervisor 107 and at least one upgrade agent 109.

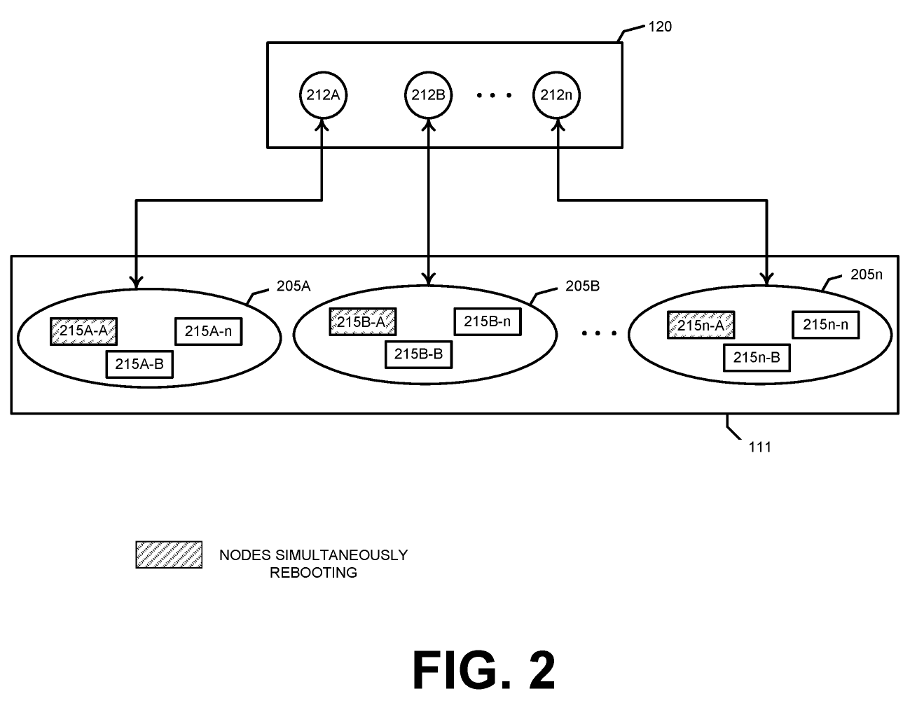

Turing now to FIG. 2, the figure illustrates computing cluster 111 comprising at least one node neighborhood 205. A neighborhood 205 may comprise at least one node 215. At least one node 215 may correspond to at least one computing systems resource 212, which may be referred to as, or correspond to, a network pool of resource, such as, for example, network access points or network addresses, that may facilitate at least one client computing system accessing the at least one node, including facilitating access to data stored by the at least one node. During an upgrade operation corresponding to at least one node 215, the at least one node may be rebooted to implement new or revised software code. Each of the at least one node 215 has the potential for data being unavailable to at least one client computing system that may be configured to access the at least one node via at least one of the at least one computing resources 212. Data unavailability (“DU”) may occur when nodes in different neighborhoods 215 correspond to the same network pool 212 and are rebooted simultaneously during an upgrade operation, thus potentially resulting in momentary data unavailability to client computing systems than may connect to, or have access to, cluster 111 via a network pool associated with the rebooting nodes.

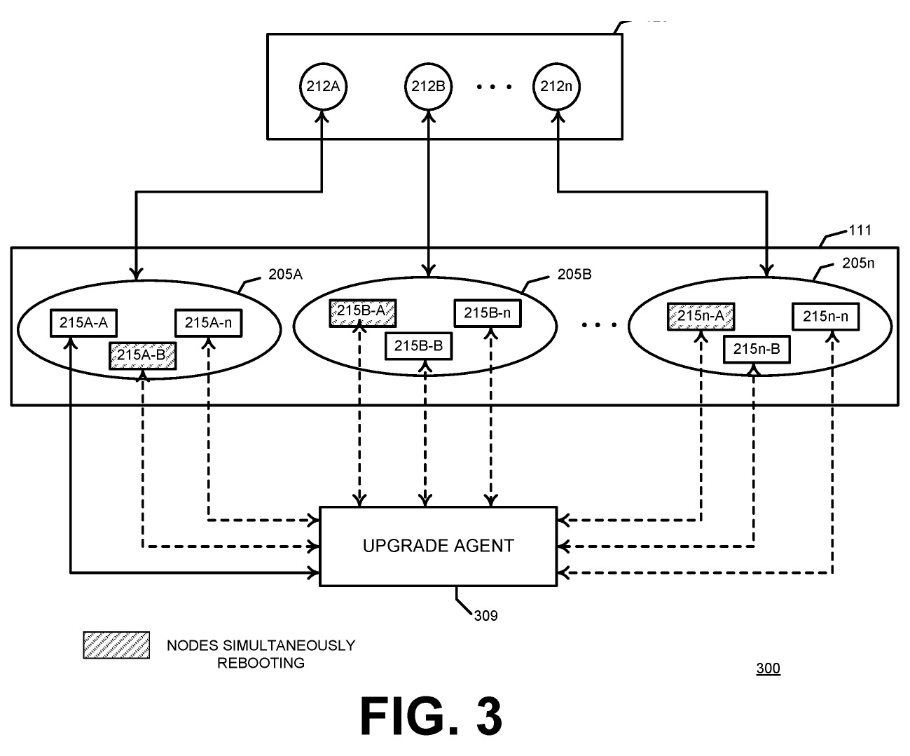

Turning now to FIG. 3, the figure illustrates an example embodiment environment 300, wherein an upgrade agent 309 is shown operating with respect to node 215 A-A. Agent 309 may be a virtual software instance implemented by computing instructions. Agent 309 may be implemented according to an application programming interface or according to application programming interface information. Agent 309 may facilitate determining whether rebooting of a node 215 may result in data unavailability with respect to a client computing system that may access the cluster via a network pool address 212 corresponding to computing resources 120. In an example embodiment, a network configuration or condition, corresponding to a network pool address 212, may result in a likelihood that rebooting a node corresponding to cluster 111 may cause data unavailability to a client computing system. An example of a configuration that may result in data unavailability if a node is rebooted may comprise a node, for example node 215A-A, being an only node from which a client computing system may be able to obtain data from cluster 111. At least one agent 309 may determine a configuration or condition corresponding to at least one node 215 during operation of the at least one agent with respect to at least one of nodes 215A-A and may report the determined configuration information or network condition information, to a computing component, for example at least one upgrade supervisor (for example supervisor 107 shown in FIG. 1), that may correspond to cluster 111. Agent 309 may operate with respect to, and may determine configuration or condition information with respect to, other nodes 215 corresponding to cluster 111 and may report information to the other nodes to the upgrade manager. In an example embodiment, a separate agent instant 309 may operate with respect to each of at least one node 215 corresponding to cluster 111. At least one upgrade supervisor or the at least one upgrade agent 309 may be implemented via computer software code and may comprise a computing instance that executes by computing equipment corresponding to node 111. The upgrade supervisor instance may comprise a different, or separate, instance with respect to each node 215. Accordingly rebooting of at least one of nodes 215 during a parallel rebooting process may be avoided, at least during a configured upgrade period, based on information received from, or based on a determination made by and provide by agent 309 or the upgrade supervisor. Upgrading, or at least rebooting, of a node may be paused until a risk of DU that could occur if the node were to be rebooted is resolved.

Agent 309 may determine whether rebooting a particular node may cause a network resource pool 212 to be associated with a lack of access to cluster 111 if a node 215 is offline. Agent 109 may generate a list of network pools 212 that may be negatively affected by rebooting of a node 212 and thus may correspond to upgrading of the node being avoided, at least temporarily. An indication of a node 212 potentially resulting in a negative effect to a network resource pool 212 if the node is rebooted may result in the node being ‘reserved’, or flagged, for non-reboot during an upgrade process. A reserved node 215 may be evaluated as reserved when determining availability of access via a network resource pool 212 to cluster 111.

Accordingly, use of agent 309 may facilitate increasing a likelihood that performing a parallel upgrade with respect to nodes 215 does not cause a pool 212 to go offline. In an embodiment, an upgrade process may provide a list of nodes that have been reserved to agent 309. In an embodiment, an upgrade process may facilitate an administrator opting out of network checks being performed as part of an unblocking aspect of the upgrade process. In an embodiment, an upgrade process may operate with respect to a reserved node if allowed by resource pools 120 and agent 309.

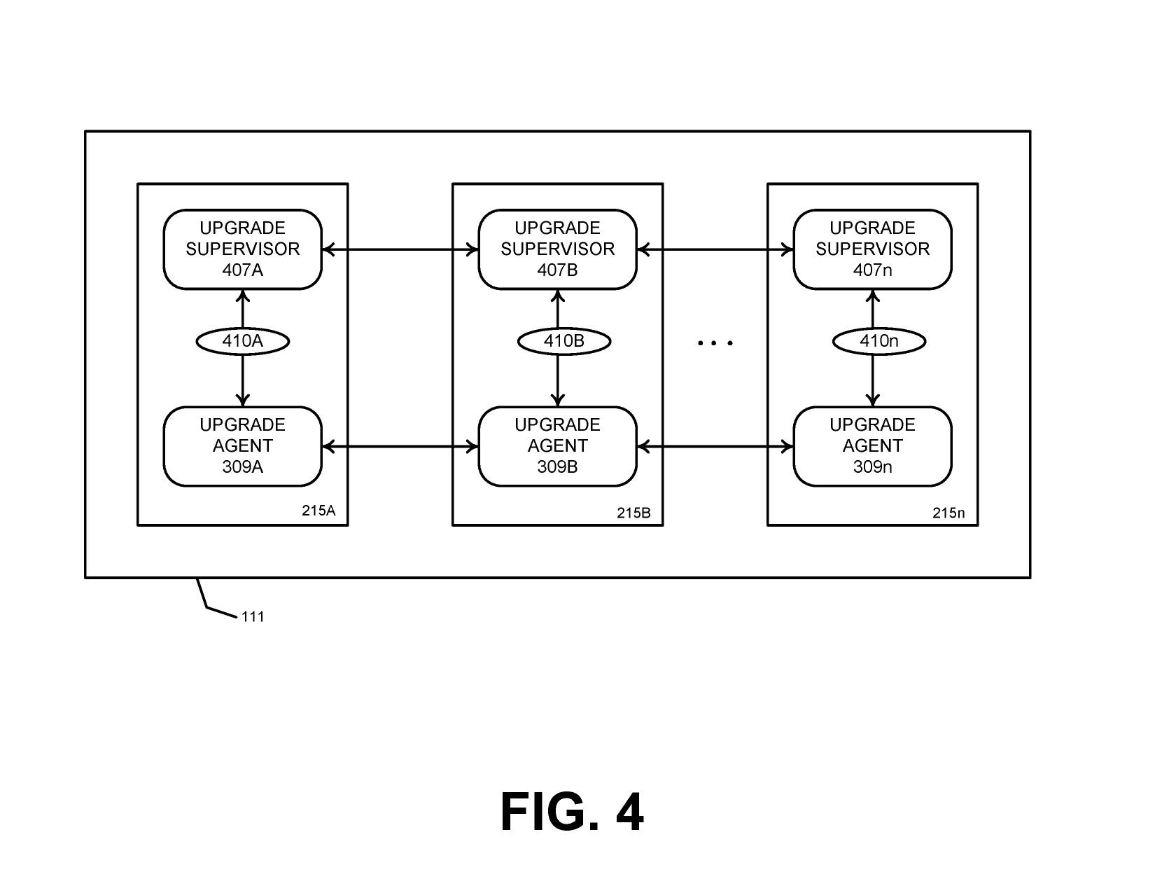

Turning now to FIG. 4, the figure illustrates example cluster 111 comprising nodes 215A – 215n. With respect to each node 215, a corresponding agent instance 309 may execute and may determine node state information corresponding to, or indicative of, whether data unavailability may occur with respect to at least one client computing system if the corresponding node is rebooted. Responsive to a query 410 from an upgrade supervisor module/instance 407 corresponding to a node 215, respective agent instance 309 corresponding to the node may report to the upgrade supervisor 407 a determined potential for data unavailability. In an example embodiment, an upgrade supervisor module/instance 407 corresponding to a node 215 may communicate with other upgrade modules 407 corresponding to other nodes associated with cluster 111. In an example embodiment, an agent 309 corresponding to a node 215 may communicate with other agents associated with cluster 111. In an example embodiment, different upgrade supervisors 407 corresponding to different nodes 215 may execute simultaneously with respect to corresponding nodes. In an example embodiment, different agents 309 corresponding to different nodes 215 may execute simultaneously with respect to corresponding nodes. In an example embodiment, an upgrade supervisor 407 corresponding to a node 215, or an upgrade agent 309 corresponding to the node, may execute independently of different upgrade supervisors or upgrade agents corresponding to different nodes. In an example embodiment, upgrade supervisors 407 or upgrade agents 309 may execute sequentially according to a configured schedule, order, rank, score, or other configuration information that may be manually determined or that may be determined based on determined data unavailability corresponding to at least one node 215 that may have determined the data unavailability before, after, or during a rebooting of at least one node 215.

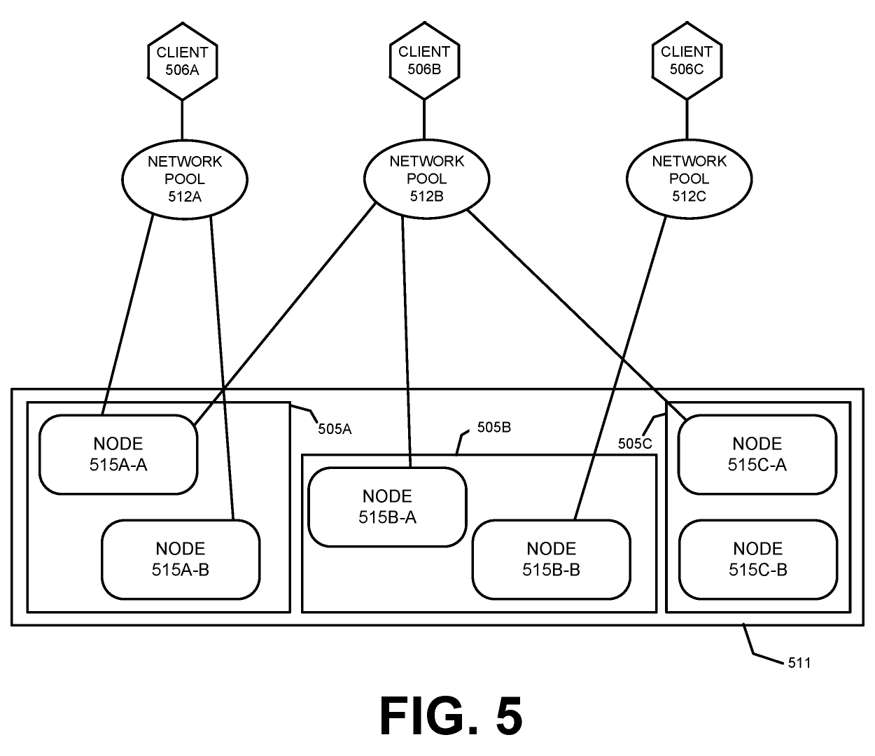

In an example configuration embodiment shown in FIG. 5, computing system cluster 511 may comprise node neighborhoods 505A, 505B, and 505 C comprising, respectively, nodes 515 A-A and nodes 515A-B, nodes 515B-A and nodes 515B-B, and nodes 515C-A and nodes 515C-B. Client computing system 506A may access data, via computing resources/network pool resources 512A corresponding to cluster 511, that may be stored by node 515A-A and node 515A-B , or one or more other nodes corresponding to cluster 111. Thus, client computing system 506A may have two different access paths to cluster 511. Client computing system 506B may access data, via computing resources/network pool resources 512B, corresponding to cluster 511 that may be stored by node 515A-A, node 515B-A, and node 515C-A. Thus, client computing system 506B may have three different access paths to cluster 511. However, client computing system 506C may only access data, corresponding to cluster 511 that may be stored by node 515B-B, via computing resources/network pool resource(s) 512C. Thus, client computing system 506C may have only one access path to cluster 511. Accordingly, at least one agent instance 309 corresponding to cluster 511 may determine that, for at least one upgrade period during which nodes 515 are to be upgraded, or rebooted, nodes 515A-A, 515A-B, 515B-A, 515C-A, or 515C-B may be rebooted separately because doing so would not preclude access by at least one of clients 506 to data stored by cluster 511, although the agent instance may determine that simultaneous rebooting of more than one of 515A-A, 515A-B, 515B-A, 515C-A, or 515C-B is not to occur during the at least one upgrade period to minimize the potential for data unavailability to at least one client. For example, if both of nodes 515A-A and 515A-B were simultaneously rebooted, client 506A would likely be unable to access data associated with client 506A that may be stored by nodes 515A-A and 515A-B, or other nodes corresponding to cluster 111. Accordingly, at least one upgrade supervisor module (e.g., a module 407 shown in FIG. 4), based on information received from at least one agent instance 309, may manage, or control, rebooting of nodes 515A-A and 515A-B to avoid both of the nodes being rebooted simultaneously to facilitate client computing system 505A having at least one access path to data associated with client computing system 505A stored by a node corresponding to cluster 511. However, in an example embodiment, at least one agent instance 309 may indicate that nodes 515A-B, 515B-A, and 515C-B may be simultaneously rebooted because client computing systems 506A, 506 B, and 506 C, would still have at least one access path to cluster 511 during the simultaneous rebooting.

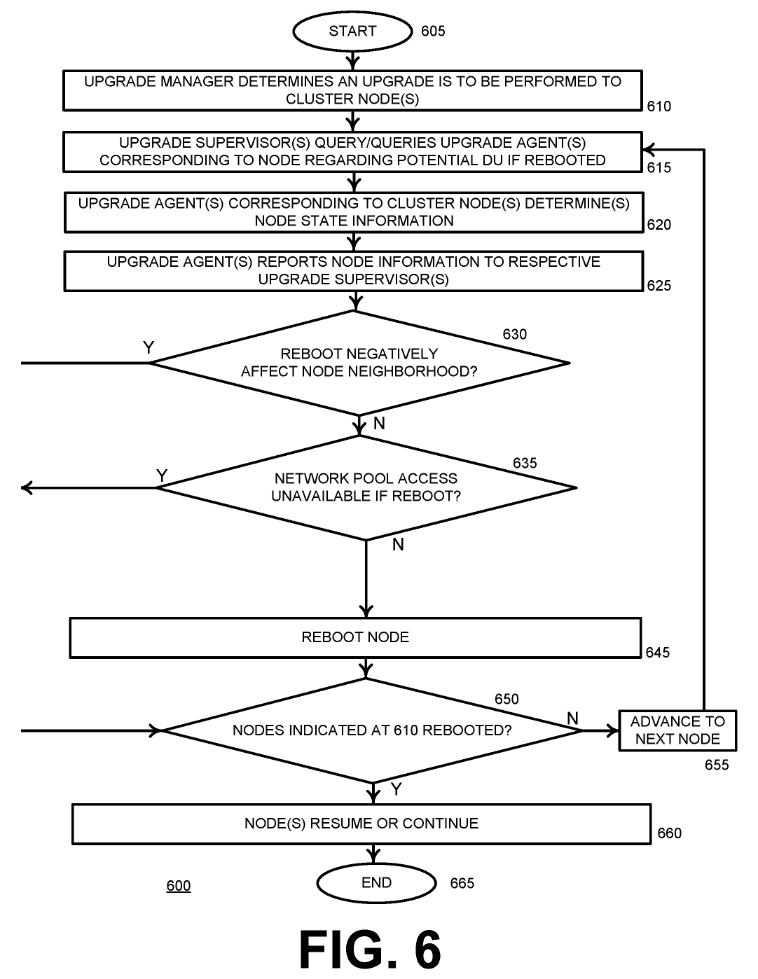

Turning now to FIG. 6, the figure illustrates a flow diagram of an example embodiment method 600 to upgrade at least one computing system component corresponding to a computing system cluster. Method 600 begins at act 605. At act 610, an upgrade manager may determine that an upgrade to at least one node corresponding to at least one cluster should be performed. Responsive to a determination made at act 610, or responsive to a query received from the upgrade manager, at act 615 an upgrade supervisor, that may correspond to the at least one cluster, may query at least one upgrade agent corresponding to the at least node regarding potential data unavailability with respect to the at least one node if the at least one node is rebooted to facilitate an upgrade, for example, an upgrade to a new version of software. At act 620, at least one upgrade agent corresponding to at least one node associated with the at least one cluster may determine node state information, corresponding to the at least one node, that may be used to determine whether the at least one node may be rebooted without inflicting data unavailability with respect to the at least one node. At act 625, at least one upgrade agent corresponding to at least one node that corresponds to the at least one cluster may report node information to an upgrade supervisor corresponding to the at least one upgrade agent.

At act 630, a determination may be made whether rebooting at least one node would negatively affect a node neighborhood and access to an associated cluster that comprises the at least one node. The determination made at act 630 may be determined by an upgrade agent, an upgrade supervisor, or an upgrade manager. If a determination is made at act 630 that rebooting at least one node corresponding to a cluster would negatively affect access to a node neighborhood with which the at least one node is associated, at act 650 a determination may be made whether all nodes determined at act 610 have either been rebooted or evaluated at act 630. If a determination is made at act 650 that all nodes determined at act 610 have either been rebooted or evaluated at act 630, method 600 may advance to act 660. At act 660, nodes that may have been rebooted may resume normal operation. Method 600 may advance to act 665 and end.

Returning to description of act 630, if a determination is made that rebooting of a particular node would not negatively affect access to a node neighborhood with which the particular node is associated, method 600 may advance to act 635. At act 635, a determination may be made whether access to the cluster via at least one network pool may be unavailable and thus result in potential data unavailability if a reboot of the particular node evaluated at act 630 is rebooted. If a determination is made at act 635 that rebooting of a particular node would result in potential data unavailability, method 600 may advance to act 650. After a determination has been made at act 650 that rebooting of a particular node would result in potential data unavailability, at act 650 a determination may be made whether all nodes determined at act 610 have either been rebooted or have been evaluated at act 630 or act 635. If a determination is made at act 650 that all nodes determined at act 610 have either been rebooted or evaluated at acts 630 or 635, method 600 may advance to act 660. At act 660, nodes that may have been rebooted may resume normal operation. It will be appreciated that if act 660 is reached without at least one node having been rebooted based on a determination made at either act 630 or act 635, the at least one node may continue operation without having been upgraded, for example, without the at least one node not having been upgraded to a newer software version. Method 600 may advance to act 665 and end.

Returning to description of act 635, if a determination is made that rebooting of a particular node may not result in access to the cluster with which the particular node is associated becoming unavailable (e.g., rebooting the node may not result in data unavailability to a client corresponding to a network pool, or a network pool address that may be used by the client to access the cluster), method 600 may advance to act 645. At act 645, the at least one node may be rebooted and method 600 may advance to act 650. If a determination is made at act 650 that all nodes determined at act 610 have either not been rebooted or have not been evaluated at either act 630 or at act 635, method 600 may advance to act 655. At act 655, a next node indication in a list, or sequence, of nodes determined at act 610, may be selected or incremented to, and method 600 may cause return and evaluation with respect to a next node associated with the next node indication. In an example embodiment, method 600 is shown in FIG. 6 returning from act 655 to act 615 such that an upgrade supervisor may query the next node associated with the next node identifier to which was advanced at act 655. In an example embodiment, method 600 may advance to a different act, for example method 600 may advance to act 630 if node state information corresponding to the nodes determined at act 610 has been determined. If a determination is made at act 650 that all nodes determined at act 610 have been either rebooted or evaluated at acts 630 or 635, method 600 may advance to act 660. At act 660, nodes resume/continue operation and method 600 may advance to act 665 and end.

To facilitate determining whether a node has been rebooted, an upgrade agent may perform several checks to determine availability of pools to which the node belongs. It is desirable to keep a network resource pool available during an upgrade (e.g., maintain access to a cluster via a network pool). For each network pool corresponding to a node, an upgrade agent may facilitate avoiding upgrading of a node if the pool is an ignored pool or if a pool corresponds to only one node. In a pool status list indicative of status, or configuration, corresponding to a network pool, a node being evaluated for possible reboot may be located and flagged in the list and each node that may be reserved may be flagged. Accordingly, a list of flagged nodes may indicate nodes that may correspond to data unavailability if nodes are rebooted according to a parallel reboot process. A count of nodes that would still be usable (e.g., non-flagged nodes) may be used to determine whether any nodes are still available. If there are no nodes available an upgrade process may not go forward with respect to nodes corresponding to a particular network pool via which a client computing system would not be able to access a cluster that comprises the nodes.

In an example embodiment, an upgrade agent may determine whether a network resource pool that is configured for dynamic assigning of network addresses corresponds to nodes that are currently usable and that are currently assigned an address and if there are nodes corresponding to the network resource pool that are available for use except that the nodes may not be assigned a network address. Thus, rebooting of a currently usable node corresponding to an assigned network address may be permitted because at least one of the usable nodes that is not currently assigned an address may be assigned an address according to a failover process based on the dynamic nature of the network. Accordingly, for a dynamic network that corresponds to a single network address, reboot of a node corresponding to the network can occur because there may be multiple nodes corresponding to the single node that can operate in place of a rebooting node while the rebooting node reboots.

For network resource pools that correspond to static assigning of network address to nodes, of if an upgrade agent is unable to determine whether other nodes may be available to take over for a node that is being rebooted and that corresponds to a dynamic network, rebooting of a node may be avoided or blocked. Such a node may be reported to, or by, an upgrade agent to facilitate the avoiding or blocking of rebooting.

A user interface may present to a user a pre-check process (e.g., before an upgrade process is initiated) that may not comprise a multi-node disjoint network check because embodiments disclosed herein may facilitate avoiding rebooting a node if doing so would result lack of access to a cluster via a pool of network resources corresponding to a node that may be rebooted during an upgrade process. In the case where a network pool corresponds to a single node network, a pre-check process may provide a notice, or recommendation, that a user, or administrator, add more nodes to be associated with a network pool or to proceed with an upgrade process with a risk of data unavailability with respect to the pool. In the case where, due to a network configuration or condition, data unavailability cannot be avoided, an upgrade process may stall. A user may be informed that an upgrade process has stalled by presenting an indication of affected nodes and corresponding pool(s) that need reconfiguration (e.g., adding at least one node to be associated with a network resource pool) to result in unblocking an upgrade process. In an embodiment, an upgrade unblock feature may facilitate an administrator either beginning a simultaneous upgrade mode that ignores all checks, or that may facilitate an administrator ignore network checks. A ‘health check’ process may be executed during an upgrade/reboot process to inform a user/administrator of a stall to the upgrade process.

Thus, according to embodiments disclosed herein, performing of prechecks for disjoint networks before beginning an upgrade process may be avoided based on data unavailability during a parallel upgrade-reboot process being minimized or eliminated, although data unavailability may occur with respect to a single-node network resource pool, prechecks may not be performed for corresponding to this scenario either since data unavailability is expected for a single-node network.

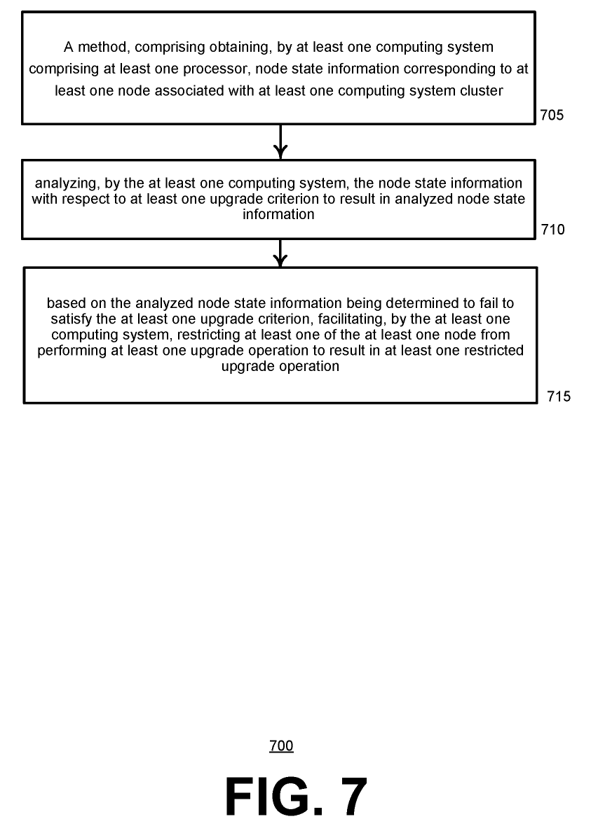

Turning now to FIG. 7, the figure illustrates an example embodiment method 700 comprising at block 705 obtaining, by at least one computing system comprising at least one processor, node state information corresponding to at least one node associated with at least one computing system cluster; at block 710 analyzing, by the at least one computing system, the node state information with respect to at least one upgrade criterion to result in analyzed node state information; and at block 715 based on the analyzed node state information being determined to fail to satisfy the at least one upgrade criterion, facilitating, by the at least one computing system, restricting at least one of the at least one node from performing at least one upgrade operation to result in at least one restricted upgrade operation.

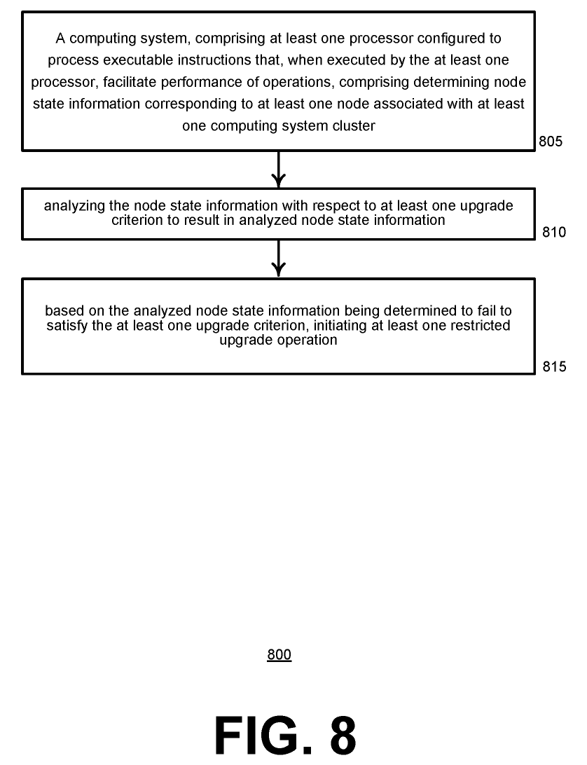

Turning now to FIG. 8, the figure illustrates a computing system, comprising at block 805 at least one processor configured to process executable instructions that, when executed by the at least one processor, facilitate performance of operations, comprising determining node state information corresponding to at least one node associated with at least one computing system cluster; at block 810 analyzing the node state information with respect to at least one upgrade criterion to result in analyzed node state information; and at block 815 based on the analyzed node state information being determined to fail to satisfy the at least one upgrade criterion, initiating at least one restricted upgrade operation.

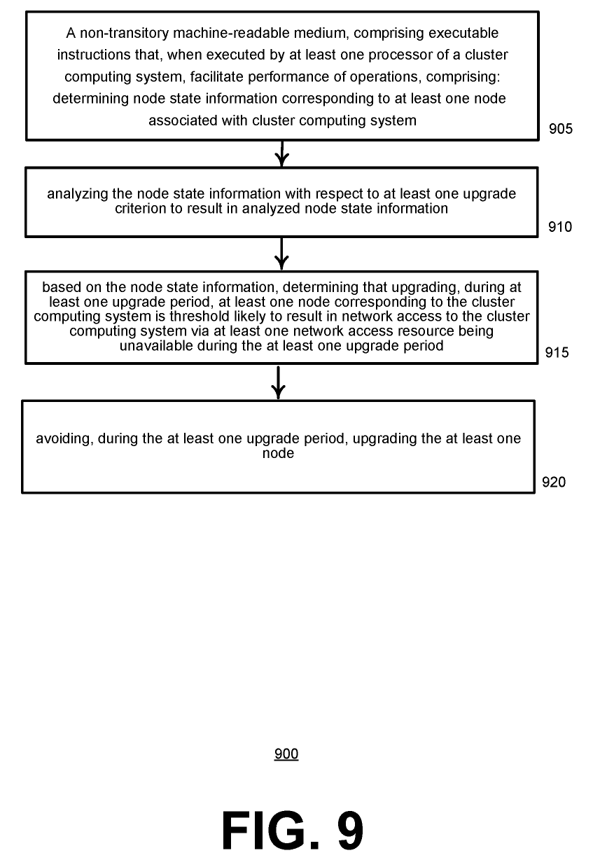

Turning now to FIG. 9, the figure illustrates a non-transitory machine-readable medium 900 comprising at block 905 executable instructions that, when executed by at least one processor of a cluster computing system, facilitate performance of operations, comprising determining node state information corresponding to at least one node associated with cluster computing system; at block 910 analyzing the node state information with respect to at least one upgrade criterion to result in analyzed node state information; at block 915 based on the node state information, determining that upgrading, during at least one upgrade period, at least one node corresponding to the cluster computing system is threshold likely to result in network access to the cluster computing system via at least one network access resource being unavailable during the at least one upgrade period; and at block 920 avoiding, during the at least one upgrade period, upgrading the at least one node.

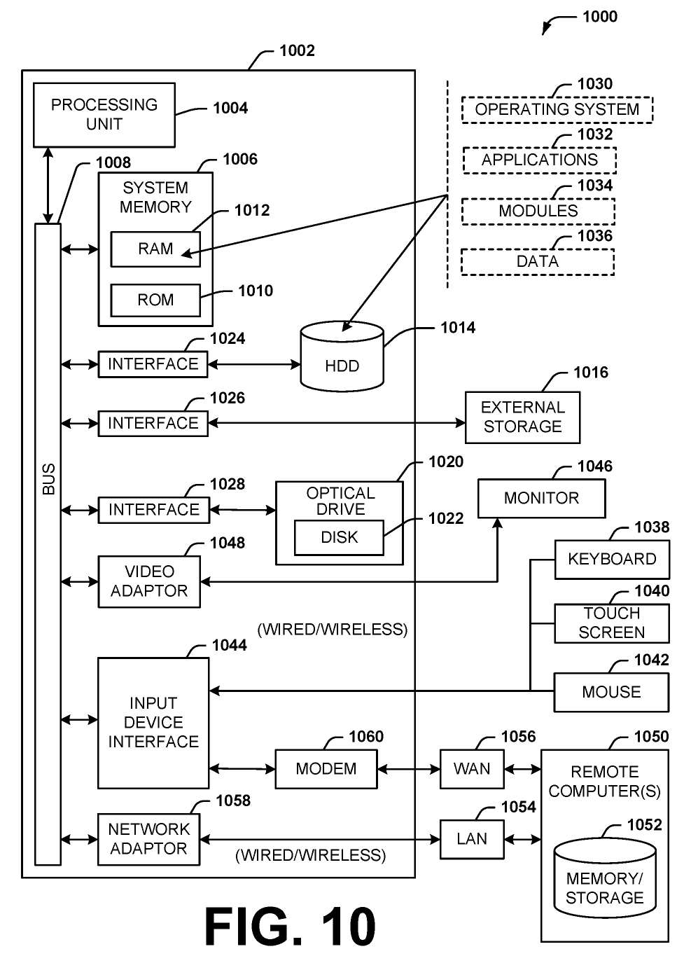

In order to provide additional context for various embodiments described herein, FIG. 10 and the following discussion are intended to provide a brief, general description of a suitable computing environment 1000 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM1012 can also include a high-speed RAM such as static RAM for caching data.

Computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1010. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE)1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM1012, including an operating system 1030, one or more application programs 1032, other program modules 1034 and program data 1036. All or portions of the operating system, applications, modules, and/or data can also be cached in the RAM1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by at least one computing system comprising at least one processor, node state information corresponding to at least one node associated with at least one computing system cluster;
analyzing, by the at least one computing system, the node state information with respect to at least one upgrade criterion to result in analyzed node state information; and
based on the analyzed node state information being determined to fail to satisfy the at least one upgrade criterion, facilitating, by the at least one computing system, restricting at least one of the at least one node from performing at least one upgrade operation to result in at least one restricted upgrade operation.

2. The method of claim 1, wherein the obtaining of the node state information is facilitated by at least one virtual computing agent corresponding to the at least one computing system.

3. The method of claim 2, wherein the at least one virtual computing agent is executed by at least one computing component corresponding to the at least one computing system.

4. The method of claim 2, wherein the node state information is communicated to at least one virtual computing supervisor being executed by at least one computing component corresponding to the at least one computing system cluster.

5. The method of claim 2, wherein the at least one virtual computing agent is facilitated by at least one application programming interface.

6. The method of claim 1, wherein the at least one upgrade operation comprises rebooting the at least one node.

7. The method of claim 1, wherein the at least one upgrade criterion being determined to fail to satisfy the at least on upgrade criterion comprises:
determining, by the at least one computing system, that performing the at least one upgrade operation is threshold likely to result in at least one network pool, corresponding to the at least one node, being unavailable during the at least one upgrade operation.

8. The method of claim 7, wherein the at least one network pool being determined to be unavailable during the at least one restricted upgrade operation is based on the at least one node being a sole node, corresponding to the at least one network pool, available for use by the at least one network pool.

9. The method of claim 7, wherein the at least one restricted upgrade operation comprises:
avoiding, by the at least one computing system, facilitating rebooting of the at least one node; and
reporting, by the at least one computing system to an upgrade manager, that the at least one node is not upgraded.

10. The method of claim 9, wherein the at least one network pool corresponds to a single network address.

11. The method of claim 1, wherein the at least one node is a first node, wherein the at least one computing system cluster comprises the first node and an available second node, wherein at least one network pool corresponds to the first node and the available second node, wherein the available second node is configured to facilitate dynamic failover network connectivity with respect to the at least one computing system cluster according to a network address that is not unique to the first node, and wherein the at least one restricted upgrade operation comprises rebooting the first node.

12. A computing system, comprising at least one processor configured to process executable instructions that, when executed by the at least one processor, facilitate performance of operations, comprising:
determining node state information corresponding to at least one node associated with at least one computing system cluster;
analyzing the node state information with respect to at least one upgrade criterion to result in analyzed node state information; and
based on the analyzed node state information being determined to fail to satisfy the at least one upgrade criterion, initiating at least one restricted upgrade operation.

13. The computing system of claim 12, wherein the analyzed node state information being determined to fail to satisfy the at least one upgrade criterion comprises at least one minimum node value failing to be satisfied during at least one upgrade operation, and wherein the at least one minimum node value comprises at least one of: at least one percentage of the at least one node being available during at least one reboot operation corresponding to the at least one node, or at least quantity of the at least one node being available during at least one reboot operation corresponding to the at least one node.

14. The computing system of claim 12, wherein the analyzed node state information comprises a determined number of connections corresponding to the at least one node during a configured tracking period, and wherein the analyzed node state information being determined to fail to satisfy the at least one upgrade criterion comprises the determined number of connections failing to be less than or equal to a number specified by a configured connection occurrence criterion.

15. The computing system of claim 14, wherein the analyzed node state information further comprises a determined quantity of traffic corresponding to the determined number of connections during the configured tracking period, and wherein the analyzed node state information being determined to fail to satisfy the at least one upgrade criterion further comprises the determined quantity of traffic failing to be less than or equal to a number specified by a configured traffic quantity criterion.

16. The computing system of claim 12, wherein the operations further comprise:
determining a number of connections corresponding to the at least one node during at least one configured tracking period to result in at least one predicted non-use period corresponding to the at least one node, and
wherein the at least one restricted upgrade operation comprises:
avoiding rebooting the at least one node during a period other than the at least one predicted non-use period, and
rebooting the at least one node during the at least one predicted non-use period.

17. A non-transitory machine-readable medium, comprising executable instructions that, when executed by at least one processor of a cluster computing system, facilitate performance of operations, comprising:
determining node state information corresponding to at least one node associated with cluster computing system;
analyzing the node state information with respect to at least one upgrade criterion to result in analyzed node state information;
based on the node state information, determining that upgrading, during at least one upgrade period, at least one node corresponding to the cluster computing system is threshold likely to result in network access to the cluster computing system via at least one network access resource being unavailable during the at least one upgrade period; and
avoiding, during the at least one upgrade period, upgrading the at least one node.

18. The non-transitory machine-readable medium of claim 17, wherein the at least one network access resource comprises a network address that corresponds to a sole access resource, corresponding to at least one client computing system other than the cluster computing system, via which the at least one client computing system is capable of accessing the cluster computing system.

19. The non-transitory machine-readable medium of claim 17, wherein the at least one node corresponding to the cluster computing system that is determined to threshold likely result in network access to the cluster computing system via the at least one network access resource being unavailable during the at least one upgrade period is a first node, and wherein the operations further comprise:
initiating upgrading of a second node corresponding to the cluster computing system during the at least one upgrade period to result in an initiated upgrade operation;
determining that the initiated upgrade operation corresponds to an initiated upgrade operation duration that equals or exceeds an upgrade duration threshold; and
based on the initiated upgrade operation being determined to correspond to the initiated upgrade operation duration that equals or exceeds an upgrade duration threshold, initiating upgrade of the first node.

20. The non-transitory machine-readable medium of claim 17, wherein the operations further comprise:
determining a number of connections corresponding to the at least one node during at least one configured tracking period to result in at least one predicted non-use period corresponding to the at least one node; and
rebooting the at least one node during the at least one predicted non-use period.
